(19) United States
(12) Patent Application Publication
(10) Pub. No.: US 2026/0183706 A1
(43) Pub. Date: Jul. 2, 2026

(54) AN ABATEMENT SYSTEM FOR TREATMENT OF EXHAUST GASES OF A VACUUM PROCESSING SYSTEM

(71) Applicant: Edwards Limited, Burgess Hill (GB)

(72) Inventors: Julian Richard Dean, Burgess Hill (GB); Rohit Dilip Pitale, Hinjewadi (IN)

(21) Appl. No.: 18/867,735

(22) PCT Filed: May 16, 2023
(86) PCT No.: PCT/GB2023/051278

§ 371 Date: Nov. 20, 2024

(30) Foreign Application Priority Data
May 30, 2022 (GB) 2207934.7

(51) Int. Cl. B01D 53/32; B01D 46/00

(52) U.S. Cl. CPC B01D 53/32; B01D 46/0027; B01D 2258/0216; B01D 2259/818

(57) ABSTRACT

An abatement system (104) for treatment of exhaust gases of a vacuum processing system (100), the abatement system (104) comprising: an inlet manifold (200), the inlet manifold (200) comprising: a single fluid inlet (224) for receiving an exhaust gas stream from the vacuum processing system (102); and a plurality of fluid outlets (226) coupled to the fluid inlet (224); and a plurality of abatement devices (202) arranged to, in use, receive the exhaust gas stream from the inlet manifold (200); wherein each abatement device (202) of the plurality of abatement devices (202) is coupled to a respective fluid outlet (226) of the inlet manifold (200).

This application is a national stage entry under 35 U.S.C. § 371 of International Application No. PCT/GB2023/051278, filed May 16, 2023, which claims the benefit of GB Application No. 2207934.7, filed May 30, 2022, the entire contents of each of which are incorporated herein by reference.

### TECHNICAL FIELD

The present disclosure relates to abatement systems and methods for treatment of exhaust gases of a vacuum processing system.

### BACKGROUND

Vacuum pumping and abatement systems are used in varied and different technological fields, for example semiconductor fabrication. Typically, in said systems, vacuum pumping equipment is used to pump gas (e.g. gas from an industrial process) out of a particular location, and an abatement device is used to abate (e.g. destroy or dispose of) undesirable substances which have been produced.

The abatement device typically comprises a burner configured to receive process gas, and to remove the undesirable substances therefrom by burning the process gas in a fuel and oxygen mixture.

### SUMMARY

In an aspect, there is provided an abatement system for treatment of exhaust gases of a vacuum processing system. The abatement system comprises: an inlet manifold, the inlet manifold comprising a single fluid inlet (e.g., only a single fluid inlet) for receiving an exhaust gas stream from the vacuum processing system, and a plurality of fluid outlets coupled to the fluid inlet; and a plurality of abatement devices arranged to, in use, receive the exhaust gas stream from the inlet manifold. Each abatement device of the plurality of abatement devices is coupled to a respective fluid outlet of the inlet manifold. Each abatement device of the plurality of abatement devices comprises a plasma abatement device for generating a plasma to decompose a component of the exhaust gas stream.

The abatement devices of the plurality of abatement devices may be substantially identical to one another.

Each abatement device of the plurality of abatement devices may be configured to convert a component of the exhaust gas stream into a liquid-soluble component at a sub-atmospheric pressure.

The inlet manifold may comprise a central inlet pipe defining the single fluid inlet of the inlet manifold. The inlet manifold may comprise a plurality of outlet pipes extending radially from the central inlet pipe, each outlet pipe defining a respective one of the fluid outlets of the inlet manifold. The plurality of outlet pipes may extend radially from the central inlet pipe at respective positions about a circumference of the central inlet pipe and at substantially the same axial position along the central inlet pipe. The outlet pipes of the inlet manifold may be substantially identical to one another.

The inlet manifold may have rotational symmetry of order greater than or equal to 2.

The abatement system may further comprise a plurality of filter devices, each filter device of the plurality of filter devices being coupled to an outlet of a respective one of the plurality of abatement devices.

The abatement system may further comprise a plurality of first flexible pipe portions, each first flexible pipe portion of the plurality of first flexible pipe portions being coupled between a respective fluid outlet of the inlet manifold and the abatement device coupled thereto.

The abatement system may further comprise an outlet manifold arranged to, in use, receive gas streams output from the plurality of abatement devices. The outlet manifold may comprises a single fluid outlet for expelling gases from the abatement system, and a plurality of fluid inlets coupled to the single fluid outlet. Each abatement device of the plurality of abatement devices may be coupled to a respective fluid inlet of the outlet manifold. The abatement system may further comprise a catchpot filter comprised in the single fluid outlet. The abatement system may further comprise a plurality of second flexible pipe portions, each second flexible pipe portion of the plurality of second flexible pipe portions being coupled between a respective fluid inlet of the outlet manifold and the abatement device coupled thereto. The outlet manifold may comprise: a central outlet pipe defining the single fluid outlet of the outlet manifold, and a plurality of inlet pipes extending radially from the central outlet pipe, each inlet pipe defining a respective one of the fluid inlets of the outlet manifold. The plurality of inlet pipes may extend radially from the central outlet pipe at respective positions about a circumference of the central outlet pipe and at substantially the same axial position along the central outlet pipe. The inlet pipes of the outlet manifold may be substantially identical to one another. The outlet manifold may have rotational symmetry of order greater than or equal to 2.

The abatement system may further comprise a plurality of gate valve pairs. Each gate valve pair may comprise a first gate valve positioned upstream of a one of the plurality of abatement devices, and a second gate valve positioned downstream of said respective abatement device. The abatement system may further comprise a plurality of purge gas inlet ports for receiving a purge gas. The abatement system may further comprise a plurality of purge gas outlet ports for outputting a purge gas. Each purge gas inlet port may be arranged between the gate valves of a respective gate valve pair. Each purge gas outlet port may be arranged between the gate valves of a respective gate valve pair. The purge gas outlet ports may be downstream of the purge gas inlet ports.

In a further aspect, there is provided a method for treating exhaust gases of a vacuum processing system. The method comprises: receiving, at a single fluid inlet of an inlet manifold, an exhaust gas stream from the vacuum processing system; outputting, at each of a plurality of fluid outlets of the inlet manifold, a respective portion of the exhaust gas stream; receiving, at each of a plurality of abatement devices, from a respective fluid outlet of the inlet manifold, a respective portion of the exhaust gas stream; and treating, by each of the plurality of abatement devices, said received respective portion of the exhaust gas stream. Each abatement device of the plurality of abatement devices comprises a plasma abatement device and the treating comprises generating a plasma to decompose a component of the exhaust gas stream.

### BRIEF DESCRIPTION OF DRAWINGS

FIG. 1 is a schematic illustration (not to scale) of a vacuum processing system.

FIG. 2a is a schematic illustration (not to scale) showing a perspective view of an abatement system.

FIG. 2b is a schematic illustration (not to scale) showing a perspective view of the abatement system coupled to inlet and outlet pipes.

FIG. 3 is a schematic illustration (not to scale) showing a top-down view of the abatement system.

FIG. 4 is a process flow chart showing certain steps of a method for treating exhaust gases in the vacuum processing system.

### DETAILED DESCRIPTION

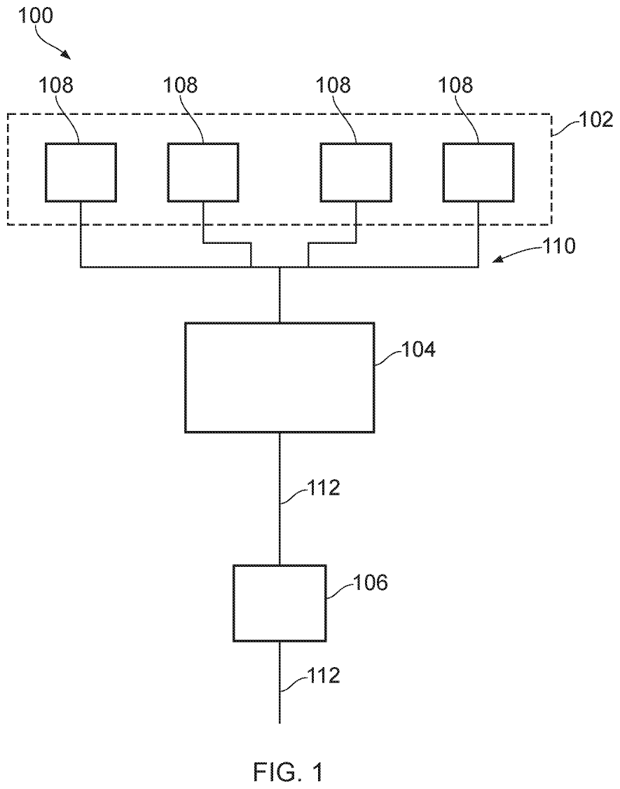

FIG. 1 is a schematic illustration (not to scale) of a vacuum processing system 100. In this example, the vacuum processing system is a semiconductor fabrication facility.

The vacuum processing system 100 comprises a semiconductor processing tool 102, an abatement system 104, and a vacuum pump 106.

The semiconductor processing tool 102 comprises a plurality of process chambers 108 in which semiconductor wafers undergo respective processes. Examples of such processes include, but are not limited to, chemical vapor deposition, physical vapor deposition, implant, etch and lithography processes.

The semiconductor processing tool 102 is coupled to the abatement system 104 via a foreline system 110. The foreline system 110 is a system of pipes for conveying fluid from the plurality of process chambers 108 to the abatement system 104.

The vacuum pump 106 is configured to pump fluids (i.e. process gases) out of the process chambers 108 of the semiconductor processing tool 102, and to the abatement system 104 via the foreline system 110. The vacuum pump 106 is further configured to pump fluids out of the abatement system 104 via an outlet line 112.

The abatement system 104 is configured to abate undesirable substances present in the fluids received from the process chambers 108 of the semiconductor processing tool 102.

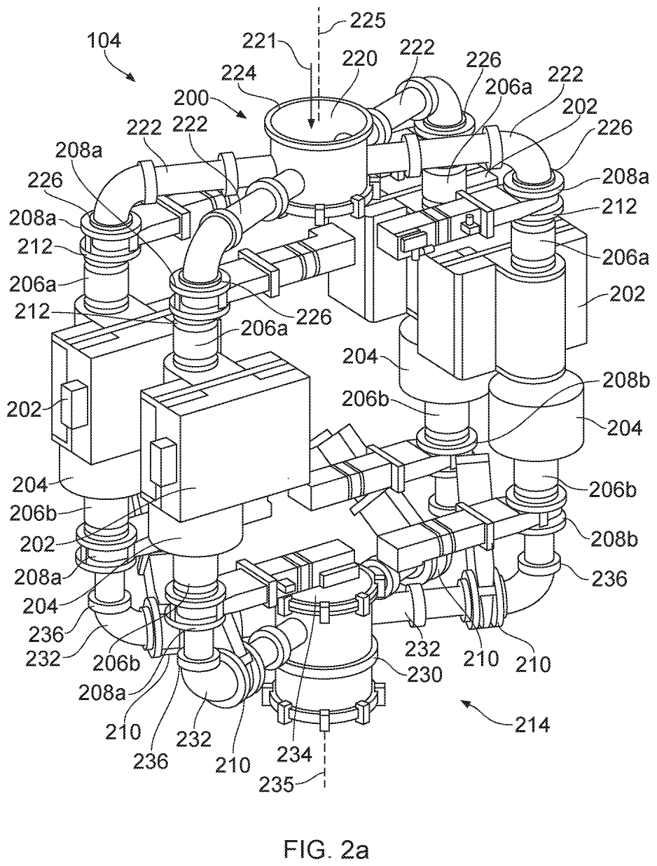

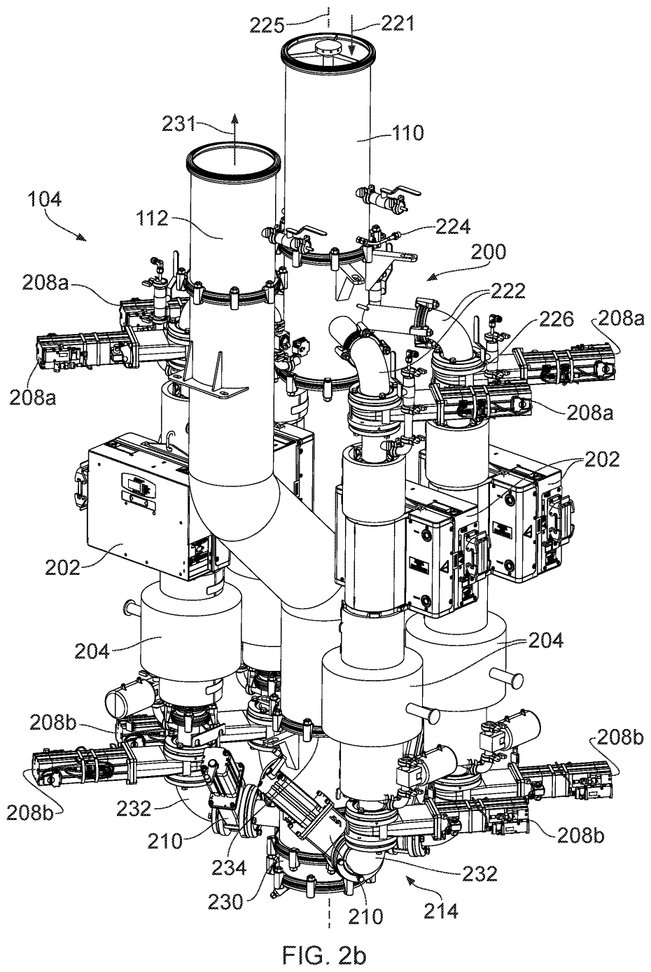

FIG. 2a is a schematic illustration (not to scale) showing a perspective view of the abatement system 104.

FIG. 2b is a schematic illustration (not to scale) showing a perspective view of the abatement system coupled to an inlet pipe (i.e. foreline 110) and outlet pipe (i.e. outlet line 112).

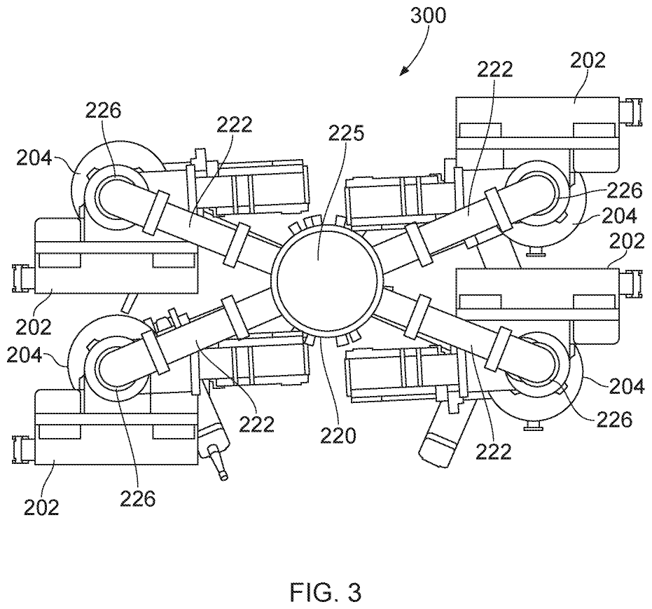

FIG. 3 is a schematic illustration (not to scale) showing a top-down view of the abatement system 104.

In this example, the abatement system 104 comprises an inlet manifold 200, a plurality of abatement devices 202, a plurality of filter devices 204, a plurality of flexible pipe portions 206a-b (including a plurality of first flexible pipe portions 206a and a plurality of second flexible pipe portions 206b), a plurality of gate valves 208a-b (including a plurality of first gate valves 208a and a plurality of second gate valves 208b), a plurality of isolation valves 210, a plurality of purge gas ports 212, and an outlet manifold 214.

The inlet manifold 200 comprises a central inlet pipe 220 and a plurality of outlet pipes 222. In this example, there are four outlet pipes 222.

The central inlet pipe 220 defines a fluid inlet 224 of the inlet manifold 200. In particular, the central inlet pipe 220 is open at one of its ends, that open end defining the fluid inlet 224 of the inlet manifold 200. The central inlet pipe 220 is closed at the end opposite to the open end. The fluid inlet 224 of the inlet manifold 200 is arranged to receive an exhaust gas stream from the semiconductor processing tool 102. This receiving of process gas is illustrated in FIGS. 2a and 2b by a solid arrow and the reference numeral 221. In particular, in this example, the fluid inlet 224 is attached to an outlet of the foreline system 110.

Each of the outlet pipes 222 extends radially from the central inlet pipe 220. Each of the outlet pipes 222 extends radially from the central inlet pipe 220 in a respective direction that is perpendicular to a central axis 225 of the central inlet pipe 220. Each outlet pipe 222 defines a respective fluid outlet 226 of the inlet manifold 200. In particular, each outlet pipe 222 comprises a first end connected to the central inlet pipe 220 and a second end opposite to the first end. Each outlet pipe 222 comprises a first opening at its first end and a second opening at its second end. The second openings of the outlet pipes are fluid outlets 226 of the inlet manifold 200.

Each outlet pipe 222 extends from the central inlet pipe 220 at a respective position about a circumference of the central inlet pipe 200. The outlet pipes 222 extend from the central inlet pipe 220 at substantially the same axial position along a length of the central inlet pipe 220. In other words, the axial positions along the length of the central inlet pipe 220 of the first ends of the outlet pipes 222 are substantially the same as each other, while their circumferential positions about the circumference of the central inlet pipe 220 vary.

In this example, in the preferred orientation for operation, which is approximately that shown in FIGS. 2a and 2b, the central inlet pipe 220 of the inlet manifold 200 is approximately vertical. The central inlet pipe 220 is arranged to receive a flow of process gases travelling in an approximately vertically downwards direction 221. Also, the outlet pipes 222 extend radially outwards from the central inlet pipe 220 in substantially horizontal directions. The outlet pipes 222 bend downwards (i.e. such that they are directed approximately vertically downwards) proximate to their second ends.

In this example, the outlet pipes 222 of the inlet manifold 200 are substantially identical to one another. The outlet pipes 222 have substantially identical diameters as each other. The outlet pipes 222 have substantially identical lengths as each other. Thus, as illustrated schematically in FIG. 3, when viewed from above, the fluid outlets 226 at the second ends of the outlet pipes 222 are located about a circle 300 centred at the central axis 225 of the central inlet pipe 220.

In this example, the inlet manifold has rotational symmetry about the central axis 225 of the central inlet pipe 220 of order 2.

The abatement devices 202 are arranged to, in use, receive the exhaust gas stream from the inlet manifold 200. Each abatement device 200 is coupled to a respective fluid outlet 226 of the inlet manifold 200, i.e. each abatement device 202 is coupled to a second end of a respective outlet pipe 222. More specifically, in this example, each abatement device 202 is coupled to a respective fluid outlet 226 via a respective one of the first flexible pipe portions 206a and a respective one of the first gate valves 208a. Each first flexible pipe portion 206a is coupled between a respective first gate valve 208a and a respective abatement device 202. The first flexible pipe portions 206a comprise bellow or bellows-like pipe portions. Each first gate valve 208a is coupled between a respective fluid outlet 226 and a respective first flexible pipe portions 206a. Thus, the first gate valves 208a are positioned upstream of respective abatement devices 202.

Each of the first gate valves 208a is configured to control a flow of a fluid (e.g. a gas) therethrough. For example, a first gate valve 208a may be fully closed to prevent or oppose gas flow therethrough. Similarly, a first gate valve 208a may be fully open so as not to restrict gas flow therethrough.

Preferably, the abatement devices 202 are substantially identical to one another. The abatement devices 202 are configured to abate, i.e. to perform abatement processes, on the received exhaust gas stream. For example, the abatement devices 202 may be configured to convert a component of the received exhaust gas stream into a liquid-soluble component at a sub-atmospheric pressure. Each abatement device 202 is a plasma abatement device for generating a plasma to decompose a component of the exhaust gas stream. For example, the abatement devices 202 may be Litmas™ Remote Plasma Source (RPS) devices. The abatement devices 202 may be configured to break down fluorine compounds within the exhaust gas stream.

The filter devices 204 are arranged to, in use, receive the decomposed gas streams from the abatement devices 202. Each filter device 204 is coupled to an outlet of a respective abatement device 202. The filter devices 204 are configured to filter particulate matter from the decomposed gas streams received from the abatement devices 202.

The filter devices 204 are arranged to, in use, output filtered gas streams to the outlet manifold 214. Preferably, the filter devices 204 are substantially identical to one another.

The outlet manifold 214 comprises a central outlet pipe 230 and a plurality of inlet pipes 232. In this example, there are four inlet pipes 232.

The central outlet pipe 230 defines a fluid outlet 234 of the outlet manifold 214. In particular, the central outlet pipe 230 is open at one of its ends, that open end defining the fluid outlet 234 of the outlet manifold 214. In this example, the fluid outlet 234 of the outlet manifold 214 is the top, or uppermost end of the central outlet pipe 230. The central outlet pipe 230 is closed at the end opposite to the open end. The central outlet pipe 230 of the outlet manifold 214 is arranged to receive a gas stream from the plurality of inlet pipes 232, and output said gas stream to the vacuum pump 106. In particular, in this example, the fluid outlet 234 is attached to an inlet of the outlet line 112. This outputting of gas is illustrated in FIG. 2b by a solid arrow and the reference numeral 231.

Each of the inlet pipes 232 extends radially from the central outlet pipe 230. Each of the inlet pipes 232 extends radially from the central outlet pipe 230 in a respective direction that is perpendicular to a central axis 235 of the central outlet pipe 230. Each inlet pipe 232 defines a respective fluid inlet 236 of the outlet manifold 214. In particular, each inlet pipe 232 comprises a first end connected to the central outlet pipe 230 and a second end opposite to the first end. Each inlet pipe 232 comprises a first opening at its first end and a second opening at its second end. The second openings of the inlet pipes 232 are fluid inlets 236 of the outlet manifold 214.

Each inlet pipe 232 extends from the central outlet pipe 230 at a respective position about a circumference of the central outlet pipe 230. The inlet pipes 232 extends from the central outlet pipe 230 at substantially the same axial position along a length of the central outlet pipe 230. In other words, the axial positions along the length of the central outlet pipe 230 of the first ends of the inlet pipes 232 are substantially the same as each other, while their circumferential positions about the circumference of the central outlet pipe 230 vary.

In this example, in the preferred orientation for operations, which is approximately that shown in FIGS. 2a and 2b, the central outlet pipe 230 of the outlet manifold 214 is approximately vertical. The central outlet pipe 230 is arranged to output a flow of gases in an approximately vertically upwards direction. Also, the inlet pipes 232 extend radially from the central outlet pipe 230 in substantially horizontal directions. The inlet pipes 232 bend upwards (i.e. such that they are directed approximately vertically upwards) proximate to their second ends.

In this example, the inlet pipes 232 of the outlet manifold 214 are substantially identical to one another. The inlet pipes 232 have substantially identical diameters as each other. The inlet pipes 232 have substantially identical lengths as each other.

In this example, the outlet manifold 214 has rotational symmetry about the central axis 235 of the central outlet pipe 230 of order 2.

The outlet manifold 214 may be substantially identical in shape and size to the inlet manifold 200.

Advantageously, the central outlet pipe 230 being arranged to output a flow of gases in an approximately vertically upwards direction tends to create a catchpot filter at the bottom (closed) end of the central outlet pipe 230. Nevertheless, in other examples, the central outlet pipe 230 may be arranged to output a flow of gases in different direction, e.g. in an approximately vertically downwards direction (e.g. the lower end of the central outlet pipe 230 may be open, while the upper end of the central outlet pipe 230 is closed).

The filter devices 204 are arranged to, in use, output the filtered gas streams to the outlet manifold 214. Each filter device 204 is coupled to a respective fluid inlet 236 of the outlet manifold 214, i.e. each filter device 204 is coupled to a second end of a respective inlet pipe 232. More specifically, in this example, each filter device 204 is coupled to a respective fluid inlet 236 via a respective one of the second flexible pipe portions 206b and a respective one of the second gate valves 208b. Each second flexible pipe portion 206b is coupled between a respective filter device 204 and a respective second gate valve 208b. The first flexible pipe portions 206a comprise bellow or bellows-like pipe portions. Each second gate valve 208b is coupled between a respective second flexible pipe portion 206b and a second end of a respective inlet pipe 232. Thus, the second gate valves 208b are positioned downstream of respective abatement devices 202.

Each of the second gate valves 208b is configured to control a flow of a fluid (e.g. a gas) therethrough. For example, a second gate valve 208b may be fully closed to prevent or oppose gas flow therethrough. Similarly, a second gate valve 208b may be fully open so as not to restrict gas flow therethrough.

Each of the isolation valves 210 is configured to control a flow of a fluid (e.g. a gas) therethrough. For example, an isolation valve 210 may be fully closed to prevent or oppose gas flow therethrough. Similarly, an isolation valve 210 may be fully open so as not to restrict gas flow therethrough. Each of the isolation valves 210 is disposed along a respective inlet pipe 232 of the outlet manifold 214.

The purge gas ports 212 are configured to receive a supply of a purge gas. The purge gas may be any suitable purge gas, such as, but not limited to, nitrogen. Each purge gas port 212 is arranged between a respective first gate valve 208a and the first flexible pipe portion 206a coupled downstream thereto.

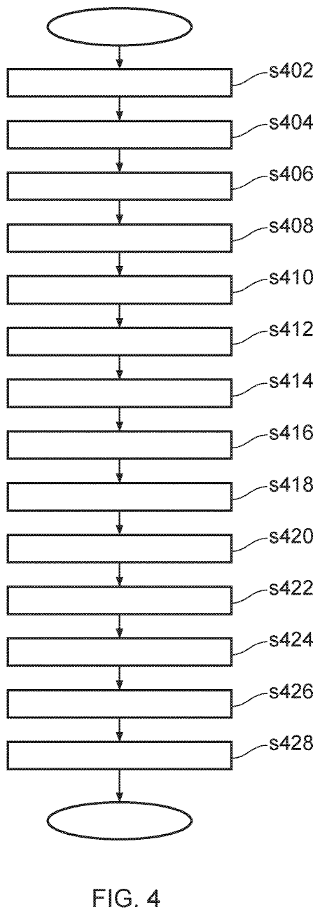

FIG. 4 is a process flow chart showing certain steps of a method 400 for treating exhaust gases of the process chambers 108 of the semiconductor processing tool 102.

It may be noted that certain of the process steps depicted in the flowchart of FIG. 4 and described below may be omitted or such process steps may be performed in differing order to that presented below and shown in FIG. 4. Furthermore, although all the process steps have, for convenience and ease of understanding, been depicted as discrete temporally-sequential steps, nevertheless some of the process steps may in fact be performed simultaneously or at least overlapping to some extent temporally.

At step s402, the vacuum pump 106 pumps process gases out of the process chambers 108 to the abatement system 104 via the foreline system 110.

At step s404, the fluid inlet 224 of the central inlet pipe 220 of the inlet manifold 200 receives the pumped process gases, i.e. a gas stream, from the foreline system 110, as indicated by arrow 221 in FIGS. 2a and 2b.

At step s406, the inlet manifold 200 splits the received gas stream, and a respective portion of the exhaust gas stream is conveyed along each outlet pipe 222 of the inlet manifold 200.

Advantageously, at least in part due to the outlet pipes 222 being substantially identical and disposed at the same axial position along the central inlet pipe 220, the gas flows along the outlet pipes 222 are substantially the same. For example, the gas flow rates and volumes along the outlet pipes 222 are approximately the same for each outlet pipe 222.

At step s408, the inlet manifold 200 outputs, at each of the plurality of fluid outlets 226, respective exhaust gas streams.

At step s410, the respective exhaust gas streams travel to inlets of respective abatement devices 202 via, in turn, respective first gate valves 208a and respective first flexible pipe portions 206a.

At step s412, each of the abatement devices 202 treats, i.e. abates, the respective exhaust gas streams received thereby.

The abatement devices 202 generate a plasma and, using the generated plasma, decompose the exhaust gas stream into different components. In other words, the exhaust gas stream may be burned using plasma.

In some examples, the abatement devices 202 receive reagent material with which the exhaust gas streams are mixed. The reagent material tends to prevent or oppose the components into which the exhaust gas streams have been decomposed from recombining. Any appropriate type of reagent material may be used.

At step s414, the abatement devices 202 output the decomposed gas streams to the filter devices 204.

At step s416, the filter devices 204 filter particulate matter from the received decomposed gas streams.

At step s418, the filter devices 202 output respective filtered gas streams.

At step s420, the respective filtered gas streams travel to fluid inlets 236 of respective inlet pipes 232 of the outlet manifold 214 via, in turn, respective second flexible pipe portions 206b and respective second gate valves 208b.

At step s422, a respective filtered gas stream is conveyed along each inlet pipe 232 to the inlet central outlet pipe 230.

At step s424, the filtered gas streams combine in the central outlet pipe 230 of the outlet manifold 200, thereby to provide a combined gas stream.

At step s426, the combined gas stream may be filtered by a further filter which may be comprised in the central outlet pipe 230 thereby to remove some or all remaining particulate matter therefrom.

At step s428, the vacuum pump 106 pumps the combined gas stream out of the outlet manifold 214 via the fluid outlet 234. The combined gas stream is pumped out of the abatement system 104 via an outlet line 112.

Thus, the method 400 is provided.

Advantageously, the above-described abatement system enables multiple abatement devices (e.g. sub-atmospheric RPSs) to be connected to a single vacuum pump inlet. The parallel arrangement of abatement devices along parallel vertically oriented arms tends to minimise or at least reduce a footprint of the abatement system, e.g. in the horizontal plane.

The use of sub-atmospheric RPSs tends to enable a wide choice of gas scrubbing technologies, post vacuum pump. RPS technology tends to be effective in breaking down fluorine compounds but, conventionally, tends to be limited in the amount of gas that can be processed at any one time, e.g. in conventional installations comprising a single RPS device mounted above a single vacuum processing pump. The above-described abatement system enables multiple sub-atmospheric RPSs to be connected to a single vacuum pump to process higher gas flows. This capability to process higher gas flows tends to facilitate connection of a single vacuum pump to multiple processing chambers, as described above.

The above-described abatement system tends to provide reductions in, for example, utility costs, system footprint, serviceability and/or performance.

The above-described abatement system advantageously provides a single inlet manifold, having a single fluid inlet. The inlet manifold multifurcates into equal distribution pipes, which tends to provide for equal gas flow to each RPS unit. Equal flow across each RPS unit tends to ensure each RPS unit does not exceed its allowable flow threshold. For example, each RPS unit may be capable of processing a maximum of 3 slm process flow. The above-described system thus tends to be capable of processing 12 slm (max) process flow, assuming each RPS unit is processing 3 slm (max). Unequal flow through the system might result in some RPS units exceeding the 3 slm limit and others being underutilised. The RPS units exceeding the 3 slm limit may not react all of the gas being presented, resulting in a potential reduction of DRE downstream. Equal flow across each RPS unit tends to address this problem.

Each RPS pipe leg may advantageously include upstream and downstream gate valves (e.g. pneumatic gate valves). Each pipe leg may advantageously include an (e.g., manual) isolation valve. Each pipe leg may advantageously include a purging facility (e.g. nitrogen purging facility). The gate valves and/or purging facility tend to provide for safe and separate isolation and service to an abatement device, even while other abatement devices continue to treat process gases. For example, first and second gate valves that are upstream and downstream, respectively, of a given abatement unit may be closed. Thus, process gas may be prevented from travelling through the given abatement unit in both upstream and downstream directions. A purge gas, e.g. nitrogen, may then be flushed through the given abatement unit thereby to remove potentially hazardous processes gases therefrom. The given abatement unit (and any devices couple thereto, e.g. the associated filter device) may then be decoupled or detached from the abatement system. Advantageously, this can be performed while the remaining abatement units are still operational. Maintenance, servicing, repair or replacement can then be performed on the given abatement unit, and the unit can then be reinstalled into the abatement system. The first and second gate valves may then be reopened, and the replaced abatement unit restarted.

Service of the abatement devices and filters may utilise a nitrogen purging function. Nitrogen may be introduced at inlet purge ports located slightly below/downstream of valve 208A, and output at outlet purge ports slightly above/upstream of valves 208B. A capability to pre-evacuate the serviced unit through the port above/upstream of a valve 208B tends to enable a leak test function to be performed on the abatement devices and filters. The capability to pre-evacuate the serviced unit through the port above/upstream of a valve 208B also tends to allow a serviced abatement device and filter to be brought back online while process vacuum continues to be maintained by the other online abatement devices.

In some cases, particulate can be generated downstream of the RPS units, and may extend or be present beyond the downstream filter. The (e.g. manual) isolation valves advantageously back-up the downstream automatic valves in case any particles cause a downstream valve to leak.

The flexible pipe portions, which may be bellow-like structures, advantageously tend to provide for vibration isolation upstream and/or downstream of the abatement devices. The flexible pipe portions may further provide for or facilitate particulate filtration. Furthermore, the flexible pipe portions advantageously tend to facilitate removal and reinstallation of abatement devices, e.g. for maintenance, servicing, repair or replacement.

The outlet manifold then brings the pipe legs back into a single outlet and tends to enable implementation of a large (e.g. catchpot) filter and a single outlet connection to the process pump.

The inlets to the abatement devices being equally spaced from the central inlet pipe of the inlet manifold tends to ensure equal flow distribution through each abatement device.

The above-described abatement system advantageously tends to provide service access for multiple abatement devices. Abatement devices may be replaced while other units remain online. The above-described abatement system advantageously tends to enable or facilitate the use of downstream wet scrubber technology enabling future Gas Recovery strategies.

The above-described abatement system advantageously utilises plasma units operable to break apart very stable bonds (like CF4) and, using the reagent gas, reconstitute the broken apart compounds into different compounds that can more easily be disposed of post vacuum pump (e.g. CF4 broken down with a hydrogen reagent may generate HF). Advantageously, by using plasma units, it tends to be possible to a gas abatement unit with a water wash (i.e., wet scrubber) which tends to remove a need for burning methane.

In the above examples, the vacuum processing system comprises a single semiconductor processing tool. However, in other examples, the vacuum processing system comprises a different number of semiconductor processing tools, and/or other processing tools.

In the above examples, the semiconductor processing tool comprises four process chambers. However, in other examples, a processing tool may comprise a different number of process chamber other than four.

In the above examples, the vacuum processing system comprises a single abatement system. However, in other examples, the vacuum processing system comprises multiple abatement systems.

In the above examples, the vacuum processing system comprises a single vacuum pump. However, in other examples, the vacuum processing system comprises multiple vacuum pumps.

In the above examples, the inlet manifold of the abatement system comprises four outlet pipes. The abatement system further comprises four abatement devices, each coupled to a respective outlet pipe of the inlet manifold. However, in other examples, the inlet manifold comprises a different number of outlet pipes (e.g. 2, 3, 5, 6, 7, or 8 outlet pipes), each of which may be coupled to a respective abatement device. Thus, the abatement system may comprises a different number of abatement devices other than four.

In the above examples, the abatement system comprises plurality (specifically, four) filter devices. However, in other examples, the abatement system comprises a different number of filter devices other than four. In some examples, one or more (e.g., all) of the filter devices may be omitted.

In the above examples, the outlet manifold of the abatement system comprises four inlet pipes. However, in other examples, the outlet manifold comprises a different number of inlet pipes (e.g. 2, 3, 5, 6, 7, or 8 inlet pipes). Each inlet pipes may be coupled to a respective abatement device.

In the above examples, the abatement system comprises a respective pair of gate valves on each abatement leg. However, in other examples, the abatement system comprises a different number of gate valves to that described above and/or one or more of the gate valves may occupy a different location along the pipework of the system to that described above. In some examples, gate valves may be omitted.

In the above examples, the abatement system comprises flexible pipe portions on each abatement leg. However, in other examples, the abatement system comprises a different number of flexible pipe portions to that described above and/or one or more of the flexible pipe portions may occupy a different location along the pipework of the system to that described above. In some examples, the flexible pipe portions may be omitted.

In the above examples, the abatement system comprises isolation valves on each abatement leg. However, in other examples, the abatement system comprises a different number of isolation valves to that described above and/or one or more of the isolation valves may occupy a different location along the pipework of the system to that described above. In some examples, the isolation valves may be omitted.

In the above examples, the inlet manifold has rotational symmetry about the central axis of the central inlet pipe of order 2. However, in other examples, the inlet manifold has rotational symmetry about the central axis of the central inlet pipe of order greater than 2. In some examples, the inlet manifold has no rotational symmetry.

In the above examples, the outlet manifold has rotational symmetry about the central axis of the central outlet pipe of order 2. However, in other examples, the outlet manifold has rotational symmetry about the central axis of the central outlet pipe of order greater than 2. In some examples, the outlet manifold has no rotational symmetry.

In some examples, thermal insulation and/or cooling (e.g. water cooling) may be provided around one or more of (e.g. all of) the abatement devices and/or one or more of (e.g. all of) the filters.

1. An abatement system for treatment of exhaust gases of a vacuum processing system, the abatement system comprising:
an inlet manifold, the inlet manifold comprising:
a fluid inlet for receiving an exhaust gas stream from the vacuum processing system; and
a plurality of fluid outlets coupled to the fluid inlet; and
a plurality of abatement devices arranged to receive the exhaust gas stream from the inlet manifold; wherein
each abatement device of the plurality of abatement devices is coupled to a respective fluid outlet of the inlet manifold; and
each abatement device of the plurality of abatement devices comprises a plasma abatement device for generating a plasma to decompose a component of the exhaust gas stream.

2. The abatement system of claim 1, wherein the abatement devices of the plurality of abatement devices are substantially identical to one another.

3. The abatement system of claim 1, wherein each abatement device of the plurality of abatement devices is configured to convert the component of the exhaust gas stream into a liquid-soluble component at a sub-atmospheric pressure.

4. The abatement system of claim 1, wherein the inlet manifold comprises:
a central inlet pipe defining the fluid inlet of the inlet manifold; and
a plurality of outlet pipes extending radially from the central inlet pipe, each outlet pipe defining a respective one of the fluid outlets of the inlet manifold.

5. The abatement system of claim 4, wherein the plurality of outlet pipes extend radially from the central inlet pipe at respective positions about a circumference of the central inlet pipe and at substantially the same axial position along the central inlet pipe.

6. The abatement system of claim 4, wherein the plurality of outlet pipes of the inlet manifold are substantially identical to one another.

7. The abatement system of claim 1, wherein the inlet manifold has rotational symmetry of order greater than or equal to 2.

8. The abatement system of claim 1, further comprising a plurality of filter devices, each filter device of the plurality of filter devices being coupled to an outlet of a respective one of the plurality of abatement devices.

9. The abatement system of claim 1, further comprising a plurality of first flexible pipe portions, each first flexible pipe portion of the plurality of first flexible pipe portions being coupled between a respective fluid outlet of the inlet manifold and the abatement device coupled thereto.

10. The abatement system of claim 1, wherein:
the abatement system further comprises an outlet manifold arranged to, receive gas streams output from the plurality of abatement devices;
the outlet manifold comprises:
a fluid outlet for expelling gases from the abatement system; and
a plurality of fluid inlets coupled to the single fluid outlet; and
each abatement device of the plurality of abatement devices is coupled to a respective fluid inlet of the outlet manifold.

11. The abatement system of claim 10, further comprising a catchpot filter comprised in the fluid outlet.

12. The abatement system of claim 10, further comprising a plurality of second flexible pipe portions, each second flexible pipe portion of the plurality of second flexible pipe portions being coupled between a respective fluid inlet of the outlet manifold and the abatement device coupled thereto.

13. The abatement system of claim 1, wherein:
the abatement system further comprises a plurality of gate valve pairs; and
each gate valve pair comprises:
a first gate valve positioned upstream of a one of the plurality of abatement devices; and
a second gate valve positioned downstream of said respective abatement device.

14. The abatement system of claim 13, wherein
the abatement system further comprises a plurality of purge gas ports for receiving a purge gas; and
each purge gas port is arranged between the gate valves of a respective gate valve pair.

15. A method for treating exhaust gases of a vacuum processing system, the method comprising:
receiving, at a fluid inlet of an inlet manifold, an exhaust gas stream from the vacuum processing system;
outputting, at each of a plurality of fluid outlets of the inlet manifold, a respective portion of the exhaust gas stream;
receiving, at each of a plurality of abatement devices, from a respective fluid outlet of the inlet manifold, a respective portion of the exhaust gas stream; and
treating, by each of the plurality of abatement devices, said received respective portion of the exhaust gas stream,
wherein each abatement device of the plurality of abatement devices comprises a plasma abatement device and the treating comprises generating a plasma to decompose a component of the exhaust gas stream.
